(19) United States
(12) Patent Application Publication
(10) Pub. No.: US 2007/0108404 A1
(43) Pub. Date: May 17, 2007

(54) METHOD OF SELECTIVELY DEPOSITING A THIN FILM MATERIAL AT A SEMICONDUCTOR INTERFACE

(76) Inventors: Michael P. Stewart, Mountain View, CA (US); Timothy W. Weidman, Sunnyvale, CA (US)

Correspondence Address: PATTERSON & SHERIDAN, LLP, 3040 POST OAK BOULEVARD, SUITE 1500, HOUSTON, TX, 77056, US

(21) Appl. No.: 11/553,878

(22) Filed: Oct. 27, 2006

Related U.S. Application Data
(63) Continuation-in-part of application No. 11/385,041, filed on Mar. 20, 2006.
(60) Provisional application No. 60/731,624, filed on Oct. 28, 2005.

(51) Int. Cl. C09K 13/00

(52) U.S. Cl. 252/79.1

(57) ABSTRACT

Embodiments of the invention provide processes to form a high quality contact level connection to devices formed on a substrate. In one embodiment, a method for depositing a material on a substrate is provided which includes exposing the substrate to a buffered oxide etch solution to form a silicon hydride layer during a pretreatment process, depositing a metal silicide layer on the substrate, and depositing a first metal layer (e.g., tungsten) on the metal silicide layer. The buffered oxide etch solution may contain hydrogen fluoride and an alkanolamine compound, such as ethanolamine diethanolamine, or triethanolamine. The metal silicide layer may contain cobalt, nickel, or tungsten and may be deposited by an electroless deposition process. In one example, the substrate is exposed to an electroless deposition solution containing a solvent and a complexed metal compound.

### CROSS-REFERENCE TO RELATED APPLICATIONS

This application is a continuation-in-part of U.S. Ser. No. 11/385,041 (APPM/010659), filed Mar. 20, 2006, which claims benefit of U.S. Ser. No. 60/731,624 (APPM/010659L), filed Oct. 28, 2005, which are both herein incorporated by reference in their entirety.

### BACKGROUND OF THE INVENTION

1. Field of the Invention

Embodiments of the invention generally relate to methods for depositing materials on substrates, and more specifically to methods for filling apertures within a high aspect ratio contact.

2. Description of the Related Art

Multilevel, 45 nm node metallization is one of the key technologies for the next generation of very large scale integration (VLSI). The multilevel interconnects that lie at the heart of this technology possess features with small critical dimensions and high aspect ratios including contacts, vias, lines, and other apertures. Reliable formation of these features is very important for the success of VLSI and the continued effort to increase quality and circuit density on individual substrates. Therefore, there is a great amount of ongoing effort being directed to the formation of void-free features with low contact resistance having high aspect ratios of 10:1 (height:width) or greater.

Tungsten is a choice metal for filling VLSI features, such as sub-micron high aspect ratio contact (HARC) on a substrate. Contacts may be formed by depositing a conductive interconnect material, such as tungsten into an aperture (e.g., via) formed in the surface of a dielectric that has been deposited on a semiconducting substrate that has a number of heavily doped regions, which in some cases form the source or drain of a MOS device. A high aspect ratio of such an opening may inhibit deposition of a conformal conductive interconnect material to fill an aperture. Often, the tungsten material is not conformally deposited within the aperture to fill the HARC. Although tungsten is a popular interconnect material, vapor deposition processes for depositing tungsten commonly suffer from a void or a seam type of defect within the contact plug, as illustrated in FIG. 1C.

FIG. 1A depicts a schematic cross-sectional view of an integrated circuit device on substrate 100 containing a via or aperture 105 formed in dielectric layer 104 to expose contact layer 102. During a vapor deposition process that may include chemical vapor deposition (CVD) or atomic layer deposition (ALD), a tungsten layer 106 is deposited on dielectric layer 104 and within aperture 105 including on contact layer 102 and the sidewalls of dielectric layer 104 to form plug 103, as illustrated in FIG. 1B. Near the opening 107 of plug 103, tungsten layer 106 may pinch off, depicted in FIG. 1C, so that plug 103 maintains a seam or a void 108 therein. During a subsequent chemical mechanical polishing (CMP) process that removes a portion of tungsten layer 106 and dielectric layer 104 from the surface of substrate 100, void 108 may be breached or exposed to form gap 100 within plug 103, as illustrated in FIG. 1D. FIG. 1E depicts conductive layer 112 (e.g., copper) deposited on substrate 100 forming void 114 by enclosing gap 110. Substrate 100 may contain additional layers of material depending on the overall architecture of the electronic device. For example, dielectric layer 104 may be covered by a barrier layer (not shown) thereon prior to the deposition of conductive layer 112 and/or conductive layer 112 may also contain a barrier layer (not shown) thereon prior to the deposition of layer 120.

Defects, such as a seam or a void 114, may cause a series of problems during the fabrication of electronic devices depicted herein. The resistance to current flow through the plug 103 is impaired due to the lack of tungsten material in the void 114. However, a more serious obstacle during fabrication is the displacement of voids from one layer to the next. For example, subsequent fabrication processes of substrate 100 may include the deposition of layer 120 (e.g., dielectric layer) on conductive layer 112. During subsequent thermal processing, such as an annealing process, the material 116 from conductive layer 112 may diffuse into void 114 and form a void 118 within conductive layer 112. As illustrated in FIG. 1F, material 116 may not diffuse completely to the bottom of void 114. The defect formed in the conductive layer 112, such as void 118, will increase the resistance of the circuit containing the defect and thus affect device performance. Ultimately, the defects in the conductive layer 112 can affect the device yield of the fabricated substrate.

Contact level metallization processes also require the formation of a silicide at the doped silicon source or drain interface to reduce the contact resistance and thus improve the speed of the formed devices. Typically, conventional contact level metallization processes require the time consuming and complex process steps of depositing a metal layer that will form a silicide at the doped silicon interface (e.g., source or drain interface), removing the excess metal layer from the “field” (e.g., top surface of the substrate in which the features are formed) by use of a CMP type process, performing a high temperature anneal process to form a metal silicide layer, depositing a liner/barrier layer (e.g., titanium nitride, titanium, tantalum, tantalum nitride) over the formed metal/metal silicide layer, and then filling the contact feature formed in the dielectric layer with tungsten using a CVD process. Since the contact level metallization process is relatively complex and requires a number of process steps, the chance of misprocessing the substrate or the chance that contamination will affect the device yield is very high. Therefore, a process that is less complex, is less likely to be misprocessed and/or is less likely to be contaminated is needed.

Different types of cleaning and etching compositions and processes have been used during the fabrication of microelectronic components. Etching processes for removing material, sometimes in selective areas, have been developed and are utilized to varying degrees. Moreover, the steps of etching different layers which constitute, for instance, the finished integrated circuit chip are among the most critical and crucial steps. Often, an oxide-free silicon surface of a substrate is essential prior to performing a subsequent process. In many processes, the silicon substrate is processed to form contacts, vias and other apertures, as well as other fabricated features. Subsequently, the substrate surface contains undesirable native oxides and desired thermal oxides contained within features.

Native oxide surfaces generally contain a metastable lower quality oxide (e.g., SiOₓ, where x is usually less than 2) compared to the much more stable oxide materials that are typically used to form features (e.g., SiO₂), such as thermal oxides. The lower-density native oxide, having a larger concentration of defects, is much easier to remove from a substrate surface than most thermally deposited oxides. However, many etch solutions that are effective at removing native oxides also remove or damage desirable thermal oxides. Buffered oxide etch (BOE) solutions have been used to remove native oxides, but suffers from a lack of selectivity and also etches thermal oxides. BOE solutions are often highly acidic aqueous solution (e.g., pH<3.5) containing complexes of hydrofluoric acid and a conjugate such as ammonia (NH₃) or tetramethylammonium hydroxide ((CH₃)₃N(OH)).

Alternatively, plasma-assisted cleaning processes have been used to remove native oxide layers from substrate surfaces. Usually, a plasma-assisted cleaning process removes oxygen atoms from the substrate surface by chemically reducing the oxide with atomic-hydrogen. A plasma-assisted cleaning process is usually faster than other cleaning processes, such as a BOE process. However, plasma-assisted cleaning processes suffer many shortcomings that include providing little or no oxide selectivity (i.e., native oxide over thermal oxide), over etching, and plasma damage to various regions on the substrate surface.

Therefore, there is a need for a method to form a contact plug within a contact structure (e.g., HARC), wherein the plug is formed free of voids. There is also a need for an etching process and composition that may be used to selectively remove native oxides over thermal oxides.

### SUMMARY OF THE INVENTION

In one embodiment, a method for depositing a material on a substrate is provided which includes exposing a substrate to a buffered oxide etch (BOE) solution to form a silicon hydride layer on the substrate during a pretreatment process, depositing a metal silicide layer on the substrate, and depositing a first metal layer on the metal silicide layer. The metal silicide layer may contain cobalt, nickel, tungsten, alloys thereof, or combinations thereof and may be deposited by exposing the substrate to a deposition solution during an electroless deposition process. In one example, the deposition solution contains a solvent (e.g., acetonitrile or propylene glycol monomethyl ether) and a complexed metal compound, such as cobalt tetracarbonyl, nickel dicyclooctadiene, or tungsten carbonyl. A second metal layer may be deposited on the first metal layer and either the first or second metal layer may contain tungsten or a tungsten alloy.

In another embodiment, a preclean solution (e.g., BOE solution) may be degassed prior to exposing the substrate to the preclean solution. The BOE solution may contain hydrogen fluoride and an alkanolamine compound, such as ethanolamine (EA), diethanolamine (DEA), or triethanolamine (TEA). In one example, the method further includes the buffered oxide etch solution further contains diethanolamine and triethanolamine, each independently at a concentration by weight within a range from about 0.5% to about 10% (e.g., 2%-3%), hydrogen fluoride at a concentration by weight within a range from about 0.5% to about 10% (e.g., 1%-3%), and water at a concentration by weight within a range from about 80% to about 98% (e.g., 88%-94%). The buffered oxide etch solution may have a pH value within a range from about 3.5 to about 5 and a viscosity within a range from about 10 cP to about 30 cP.

Other embodiments of the invention are provided which include compositions of BOE solutions and methods that use the BOE solutions during a process to selectively remove a native oxide layer from a substrate surface. The BOE solutions generally contain alkanolamine compounds and an etchant, such as hydrogen fluoride. In one embodiment, the viscosity of the BOE solution may be adjusted by varying a concentration ratio of at least two alkanolamine compounds. A BOE solution having a viscosity within a range from about 10 cP to about 30 cP has superior wetting properties on a substrate surface during a process to selectively remove native oxide layers therefrom.

In one embodiment, a composition of a BOE solution is provided which includes, by weight, a first alkanolamine compound at a concentration within a range from about 0.5% to about 10%, a second alkanolamine compound at a concentration within a range from about 0.5% to about 10%, hydrogen fluoride at a concentration within a range from about 0.5% to about 10%, water at a concentration within a range from about 80% to about 98%, a pH value within a range from about 3.5 to about 5, and a viscosity within a range from about 10 cP to about 30 cP. In one example, the first alkanolamine compound is at a concentration within a range from about 1% to about 5%, the second alkanolamine compound is at a concentration within a range from about 1% to about 5%, the hydrogen fluoride is at a concentration within a range from about 1% to about 5%, the water is at a concentration within a range from about 85% to about 95%, the pH value is within a range from about 3.8 to about 4.8, and the viscosity is within a range from about 12 cP to about 28 cP. In another example, the first alkanolamine compound is at a concentration within a range from about 2% to about 3%, the second alkanolamine compound is at a concentration within a range from about 2% to about 3%, the hydrogen fluoride is at a concentration within a range from about 1% to about 3%, the water is at a concentration within a range from about 88% to about 94%, the pH value is within a range from about 3.5 to about 5, preferably, from about 4 to about 4.5, and the viscosity is less than about 50 cP, such as within a range from about 15 cP to about 25 cP. In another example, the first alkanolamine compound is at a concentration of about 3%, the second alkanolamine compound is at a concentration of about 2%, the hydrogen fluoride is at a concentration of about 2%, the water is at a concentration of about 92%, the pH value is within a range from about 4 to about 4.5 and the viscosity is less than about 50 cP, such as within a range from about 15 cP to about 25 cP.

In another embodiment, a weight ratio of the first alkanolamine compound to the second alkanolamine compound is within a range from about 1 to about 5, for example, about 1.5. The first and second alkanolamine compounds may be different alkanolamine compounds selected from EA, DEA, TEA, or derivatives thereof. For example, the first alkanolamine compound may be DEA and the second alkanolamine compound may be TEA. In another example, the first alkanolamine compound is DEA the second alkanolamine compound is EA. In another example, the first alkanolamine compound is TEA the second alkanolamine compound is EA. In other examples, the first alkanolamine compound is DEA at a concentration to have the viscosity within a range from about 15 cP to about 25 cP or at a concentration by weight within a range from about 1% to about 15%.

In another embodiment, a composition of a BOE etch solution is provided which includes a first alkanolamine and a second alkanolamine compound at a weight ratio concentration to form a viscosity within a range from about 10 cP to about 30 cP, hydrogen fluoride at a concentration by weight within a range from about 0.5% to about 10%, water at a concentration by weight within a range from about 80% to about 98%, a pH value within a range from about 3.5 to about 5, and a viscosity within a range from about 10 cP to about 30 cP. The first and second alkanolamine compounds may include EA, DEA, TEA, or other alkanolamine derivatives. In one example, the weight ratio concentration of the first alkanolamine compound to the second alkanolamine compound is within a range from about 1 to about 5, such as about 1.5 or about 1.1. In another example, the viscosity of the BOE solution is within a range from about 12 cP to about 28 cP, preferably, from about 15 cP to about 25 cP.

In another embodiment, a composition of the BOE solution is provided which further includes a pH adjusting agent, such as hydrofluoric acid, additional alkanolamine compounds, sulfuric acid, ammonium hydroxide, tetramethylammonium hydroxide, derivatives thereof, or combinations thereof. In one example, the BOE solution contains the pH adjusting agent at a concentration to have a pH value within a range from about 3.5 to about 5, preferably, from about 3.8 to about 4.8, and more preferably, from about 4 to about 4.5.

In another embodiment, a method for selectively removing an oxide layer from a substrate surface is provided which includes providing a substrate having a native oxide surface and a feature surface, exposing the substrate to a buffered oxide etch solution to remove the native oxide surface, form a native surface, and preserve the feature surface on the substrate. In one example, the buffered oxide etch solution contains a first alkanolamine compound at a concentration by weight within a range from about 0.5% to about 10%, a second alkanolamine compound at a concentration by weight within a range from about 0.5% to about 10%, hydrogen fluoride at a concentration by weight within a range from about 0.5% to about 10%, water at a concentration by weight within a range from about 80% to about 98%, a pH value within a range from about 3.5 to about 5, and a viscosity within a range from about 10 cP to about 30 cP.

In another embodiment, a composition of a BOE solution is provided which includes DEA at a concentration by weight within a range from about 0.5% to about 10%, TEA at a concentration by weight within a range from about 0.5% to about 10%, HF at a concentration by weight within a range from about 0.5% to about 10%, water at a concentration by weight within a range from about 80% to about 98%, a pH value within a range from about 3.5 to about 5 and a viscosity within a range from about 10 cP to about 30 cP.

In one example, the composition of the buffered oxide etch solution contains the DEA at a concentration within a range from about 1% to about 5%, the TEA at a concentration within a range from about 1% to about 5%, the HF at a concentration within a range from about 1% to about 5%, the water at a concentration within a range from about 85% to about 95%, the pH value within a range from about 3.8 to about 4.8 and the viscosity within a range from about 12 cP to about 28 cP. In another example, the composition of the buffered oxide etch solution contains the DEA at a concentration within a range from about 2% to about 3%, the TEA is at a concentration within a range from about 2% to about 3%, the HF is at a concentration within a range from about 1% to about 3%, the water is at a concentration within a range from about 88% to about 94%, the pH value is within a range from about 4 to about 4.5, and the viscosity is within a range from about 15 cP to about 25 cP. In another example, the composition of the buffered oxide etch solution contains the DEA is at a concentration of about 3%, the TEA is at a concentration of about 2%, the HF is at a concentration of about 2%, the water is at a concentration of about 92%, the pH value is within a range from about 4 to about 4.5, and the viscosity is within a range from about 15 cP to about 25 cP. The weight ratio of the DEA to the TEA is within a range from about 1 to about 5, preferably, the weight ratio is about 1.5 or less and the viscosity is about 23 cP.

In another embodiment, a method for selectively removing an oxide layer from a substrate surface is provided which includes providing a substrate having a native oxide surface and a feature surface and exposing the substrate to a buffered oxide etch solution to remove the native oxide surface while forming a native surface and preserving the feature surface on the substrate. The BOE solution may contain DEA at a concentration by weight within a range from about 0.5% to about 10%, TEA at a concentration by weight within a range from about 0.5% to about 10%, HF at a concentration by weight within a range from about 0.5% to about 10%, water at a concentration by weight within a range from about 80% to about 98%, a pH value within a range from about 3.5 to about 5, and a viscosity within a range from about 10 cP to about 30 cP. The pH value of the BOE solution may be adjusted to a point of zero charge of silicon, such as within a range from about 4 to about 4.5. The BOE solution may have a weight ratio of the DEA to the TEA within a range from about 1 to about 5. In one example of the BOE solution, the weight ratio is about 1.5 and the viscosity is about 23 cP.

The method further provides that the substrate is exposed to the BOE solution for a time period within a range from about 10 seconds to about 120 seconds preferably, from about 15 seconds to about 60 seconds, for example, about 30 seconds. The substrate may be exposed to a rinse solution subsequent to the BOE solution. Thereafter, a metal-containing material, such as a barrier layer or a metal silicide layer, may be deposited or formed on the native surface.

### BRIEF DESCRIPTION OF THE DRAWINGS

So that the manner in which the above recited features of the invention are attained and can be understood in detail, a more particular description of the invention briefly summarized above, may be had by reference to the embodiments thereof which are illustrated in the appended drawings. It is to be noted, however, that the appended drawings illustrate only typical embodiments of this invention and are therefore not to be considered limiting of its scope, for the invention may admit to other equally effective embodiments.

FIGS. 1A-1F illustrate schematic cross-sectional views of an integrated circuit formed by a process described in the art;

FIGS. 2A-2G illustrate schematic cross-sectional views of an integrated circuit formed by a process to fill a device aperture described within an embodiment herein;

FIG. 3 illustrates a flow chart depicting an electroless deposition process as described within an embodiment herein;

FIG. 4 illustrates a flow chart depicting an preclean process as described within an embodiment herein;

FIG. 5 illustrates a flow chart depicting an electroless deposition process as described within an embodiment herein;

FIG. 6 illustrates a flow chart depicting a process described by an embodiment herein; and

FIGS. 7A-7E illustrate cross-sectional views of a substrate during different stages of fabrication processes described by embodiments herein.

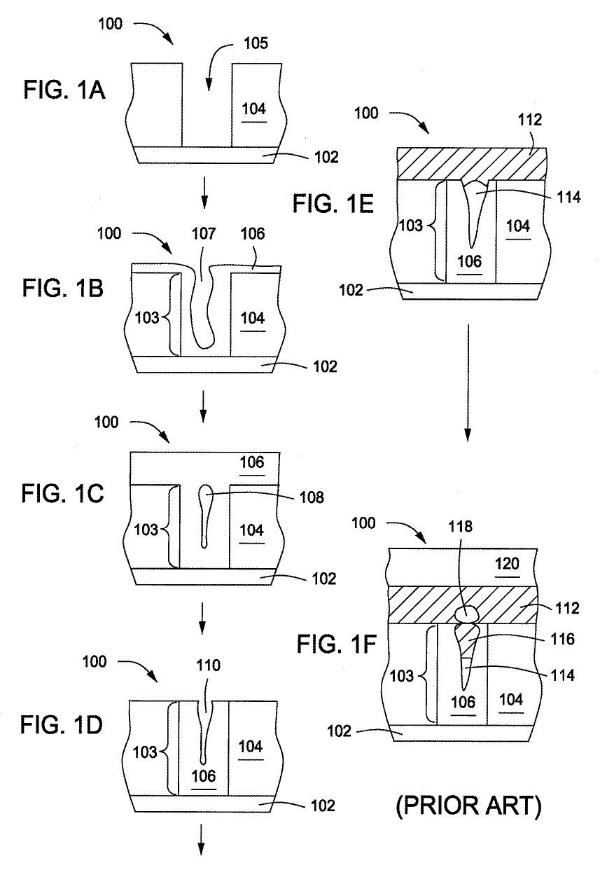

### DETAILED DESCRIPTION OF THE PREFERRED EMBODIMENT

Embodiments of the invention provide processes to form a high quality contact level connection to devices formed on a silicon substrate. Embodiments of the invention also include methods of preventing, or minimizing, oxide incorporation into formed metal contact, which will improve the electrical resistance and thus speed of the formed device. The methods as described herein are also useful in preventing the attack of the exposed regions on the surface of the substrate where the contact is to be formed, since the methods described herein generally avoid the conventional aqueous electroless chemistries that are known to cause damage to the exposed silicon surfaces at the contact interface.

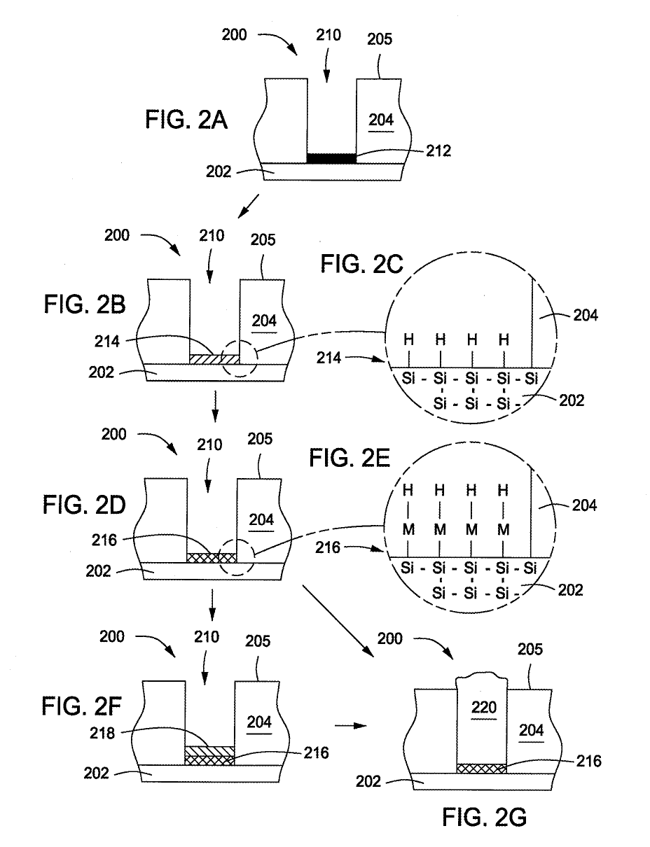

FIG. 2A illustrates a cross-sectional view of substrate 200 having contact level aperture 210 formed into dielectric layer 204. Dielectric layer 204 may generally contain an insulating material that includes silicon dioxide and other silicon oxides silicon on insulator (SOI), silicon oxynitride, fluorine-doped silicate glass (FSG), or carbon-doped silicon oxides, such as SiOₓC_{y}, for example, BLACK DIAMOND® low-k dielectric, available from Applied Materials, Inc., located in Santa Clara, Calif. Contact level aperture 210 may be formed in dielectric layer 204 using conventional lithography and etching techniques to expose the silicon junction 202, such as a MOS type source or drain interface. Silicon junction 202 is generally a doped silicon region, such as a n+ or p+ doped silicon region.

An oxide surface 212 is typically formed at the surface of the silicon junction 202 during handling in air, or after the etching and ashing processes used to form contact level aperture 210. Oxide surface 212 may be a continuous layer or a discontinuous layer across the surface of silicon junction 202 and include a surface terminated with oxygen, hydrogen, hydroxides, a metal or combinations thereof. The oxide surface 212 formed at the silicon junction 202 is generally a metastable lower quality oxide (e.g., SiOₓ, where x is between about 0.1 and 2) compared to the much more stable oxide materials that are typically used to form the dielectric layer 204 (e.g., SiO₂). The metastable lower quality oxides (e.g., the “native oxide” ) are much easier to remove from the surface of the silicon junction 202 than the oxides used to form the dielectric layer 204 due to the lower activation energy required to remove this layer.

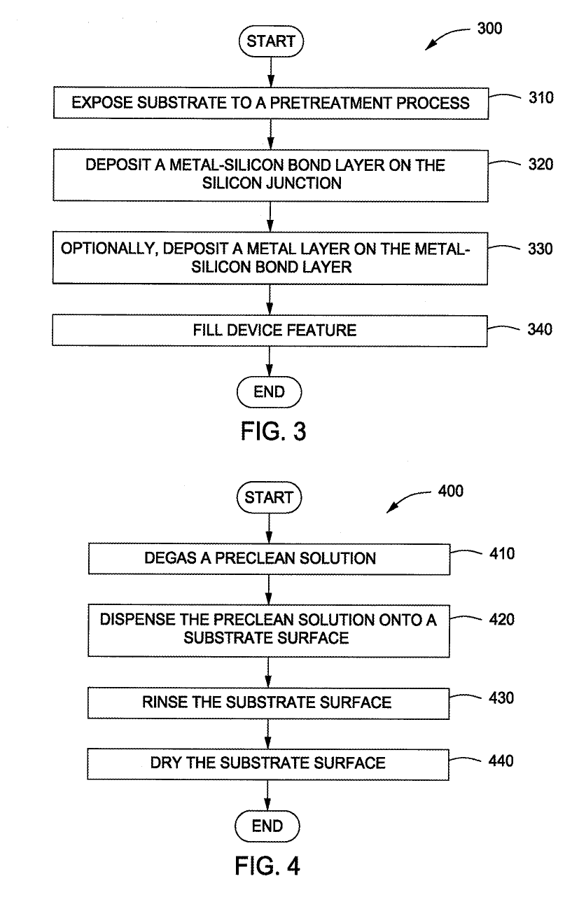

FIG. 3 illustrates a process sequence 300 having series of method steps 310-340 that may be used to fill the contact level aperture 210. The method steps 310-340 are described in relation to FIGS. 2A-2G, which illustrate various cross-sectional views of the contact level aperture 210 during the different phases of the process sequence 300.

Oxide Removal and Silicon Hydride Formation Process

The first step 310 of the inventive process sequence 300 is adapted to remove the low quality oxide layer from the surface of silicon junction 202 and then form silicon hydride layer 214 that may contain silicon, silicon hydrides (e.g., SiHₓ, where x=1, 2 or 3), silicon hydroxides (e.g., Si(OH)ₓ, where x=1, 2 or 3), or combinations thereof (e.g., SiHₓ(OH)_{y}, where x=1 or 2 and y=1 or 2 on the surface of silicon junction 202. Preferably, silicon hydride layer 214 substantially contains silicon hydrides. The formation of silicon hydride layer 214 may be used to facilitate the subsequent metal deposition steps described below. In general, the formation of a silicon hydride layer on silicon junction surface 202 is preferred over silicon hydroxides, since it will generally reduce the chance of incorporating oxygen into the subsequently deposited metal films or the subsequently formed silicide contact. It should be noted that the scope of the invention is not intended to be limited to the process of forming a silicon hydride layer as described herein, and thus the formation of the silicon hydride layer may be formed by any other conventional processes, such as SICONI™ plasma assisted cleaning process available from Applied Materials, Inc., Santa Clara, Calif.

FIGS. 2B-2C illustrate cross-sectional views of contact level aperture 210 after silicon hydride layer 214 has been formed on the silicon junction 202. FIG. 2C schematically illustrates a region of the silicon junction 202 shown in FIG. 2B and is intended to generally illustrate silicon hydride layer 214 formed on the silicon junction 202.

In one embodiment, the metastable low quality oxide layer is selectively removed and a silicon hydride layer is formed on the silicon junction 202 by exposing it to a preclean solution containing an acid fluoride solution and an additive, such as ethanolamine (NH₂(CH₂)₂OH or also known as EA), diethanolamine (C₄H₁₁NO₂ or also known as DEA), or triethanolamine (C₆H₅NO₃ or also known as TEA). In general, a desirable additive will tend to interact with the fluoride ions so that they become partially complexed and comparatively less active towards higher density silicon oxides, silicate, or silicon containing materials on the surface of substrate 200. The additive may also have other desirable properties, which include but are not limited to: it may acts as wetting agent, it may act as a pH and fluoride buffer, and/or it may acts as a chelating agent or stabilizer for the etched silicon atoms leaving the surface of substrate 200 and enter the solution. An additive that acts as a wetting agent may be useful to help improve wettability of the substrate surfaces (e.g., more hydrophilic) and may also help improve the drying process (i.e., step 440 discussed below). In one aspect, it may be desirable to create a solution that uses a single additive, since it makes the etching process easier to control and less costly, since one doesn't need to control the amounts of multiple chemicals that may be used to perform the same functions as a single additive.

The process described herein is designed to selectively attack the metastable low quality oxide layer and not dielectric layer 204, to prevent any damage to the devices formed on substrate 200. It has been found that the combination of a fluoride and DEA is effective at removing the metastable low quality oxide layer that tends to form on silicon. Due to the chelating and hydrogen bonding ability of DEA, the fluoride ions are partially complexed and less active towards higher density silicon oxides, silicate, or silicon containing materials. The selectivity, combined with the many other properties of the additive may make this embodiment of the invention useful in other IC fabrication processes and other places where wet etch selectivity between deposited or grown silicon oxide and the native oxide is required.

In one embodiment, the preclean solution used in step 310 is formed by mixing an aqueous solution containing a 1:1 solution of diethanolamine (DEA) and concentrated hydrofluoric acid that has an adjusted pH of between about 4 and about 4.5. In one aspect, the pH is adjusted by the addition of more hydrofluoric acid. In one embodiment, the pH may be adjusted to be equal to the point of zero charge (PZC or pH_{PZC}) of the substrate surface to reduce the attraction of charged particles to the surface of the substrate. In one aspect, the pH is adjusted to the PZC for bare silicon which is about 4.

FIG. 4 illustrates a one embodiment of step 310 that has a series of method steps 410-440 that may be used to form silicon hydride layer 214 in a single substrate processing chamber or multiple substrate processing chambers as desired. An example of an exemplary electroless deposition chamber and system that may be used to carry out the various embodiments of the invention described herein is further described in commonly assigned U.S. Ser. No. 11/043,442, filed Jan. 26, 2005, and published as US 2005-0263066, which is herein incorporated by reference in its entirety.

In one aspect, as shown in step 410, an optional solution degas step is performed on the formed preclean solution prior to dispensing the preclean solution on the substrate in step 420 so that any trapped gasses in the preclean solution, such as oxygen may be removed. In one aspect, it may be desirable to perform the degassing step on one or more of the components of the preclean solution (e.g., the DEA solution) prior to forming the preclean solution. Step 410 may be useful to reduce, or minimize the oxidation or re-oxidation of silicon junction 202 surface, during the preclean process in step 310.

In step 420 the preclean solution is dispensed onto substrate 200 surface and is held on the substrate surface for a desired period of time. In one embodiment step 420 is completed by continually flowing the preclean solution across the substrate surface as the substrate is rotated to improve mixing and reduce the diffusion boundary layer. In one aspect, the temperature of the substrate is at about 20° C. and the preclean solution is dispensed on the substrate surface at temperature of about 20° C. In one aspect, it may be desirable to heat the preclean solution prior to dispensing it on the substrate surface.

In step 430 the substrate surface is rinsed using a solvent, such as DI water to remove any of the remaining preclean solution. In one aspect, it may be desirable to rotate the substrate during the rinsing process to assure that the rinsing process is effective. In one aspect, it may be desirable to degas the DI water prior to dispensing it on the substrate surface to remove any dissolved gasses, such as oxygen.

In step 440 a drying process is performed on the substrate to assure that the preclean solution and rinsing solvent will not affect the subsequent processing steps. In one aspect, it may be desirable to add a solvent to the rinsing solution that will promote drying of the substrate surface, such as isopropanol (IPA).

In one embodiment, all of the method steps 410-440 are performed in an environment that has a low partial pressure of oxygen and low concentration of water vapor. In this configuration the environment around the substrate will help reduce re-oxidation of silicon junction 202 and help improve the drying process. In one aspect, the chamber is continually purged with a dry nitrogen gas to achieve an environment that has a low partial pressure of oxygen and low concentration of water vapor. An example of an exemplary electroless deposition chamber and system that may be used to form an environment having a low partial pressure of oxygen and low concentration of water vapor is further described in commonly assigned U.S. Ser. No. 11/043,442, filed Jan. 26, 2005, and published as US 2005-0263066, which is herein incorporated by reference in its entirety.

Deposit Interface Metal Layer Process

FIGS. 2D and 2E illustrate step 320 of process 300 in which a metal layer is deposited on silicon hydride layer 214 to form metallic silicide hydride layer 216 on the exposed surface of silicon junction 202. In one aspect, this process may be performed on a silicon hydroxide surface which may be formed on the surface due to the interaction of the exposed surface of silicon junction 202 with residual water atmospheric oxygen exposure, or purposely formed during steps 410-440. In another aspect, this process may be performed on a surface which has both silicon hydride bonds and germanium hydride bonds (Ge—Hₓ), such as what might be present on the surfaces of some contacts whose composition includes SiGe alloys.

The deposition technique performed in step 310 is generally selective in that initiation of the film growth process involves a chemical reaction with a silicon hydride surface. Generally, a metal (e.g., element “M” in FIG. 2E) directly bonds to the silicon at the surface of silicon junction 202 to form metallic silicide hydride layer 216 (shown below and FIG. 2E). Metallic silicide hydride layer 216 contains a metal, silicon, and hydrogen, and may contain oxygen. Metallic silicide hydride layer 216 may contain metal hydrides (e.g., MHₓ, where x=1, 2, 3, 4, or higher and M=metal, such as Ni, Co, or W), silicon hydrides (e.g., SiHₓ, where x=1, 2 or 3), silicon hydroxides (e.g., Si(OH)ₓ, where x=1, 2 or 3), or combinations thereof (e.g., SiHₓ(OH)_{y}, where x=1 or 2 and y=1 or 2 on the surface of silicon junction 202. Preferably, metallic silicide hydride layer 216 substantially contains metallic silicide hydrides.

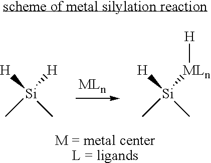

These reactions where a metal reacts with the hydride bonds are sometimes called silylation, silation, hydrosilylation, hydrosilation, oxidative addition, or metal insertion processes. Step 310, as described herein, is performed in the solution phase without the need for heating the entire substrate to high temperatures to form a silicon metal bond.

In general, the reaction that occurs during step 310 is a selective, low-temperature, liquid phase reaction that deposits thin continuous or discontinuous films of metal onto a hydride surface (e.g., silicon hydride layer 214) at ambient pressure and low temperature. In one aspect, the temperature during process 300 is maintained below the boiling point of the various deposition solution components. The silylation reaction involves a solution phase delivered metal complex that inserts itself between the silicon and hydrogen in the Si—H bond, creating two new bonds to the metal center and thereby increasing the oxidation state of the metal by two electrons. Therefore, the deposited metal film is chemically bonded to the silicon surface, addressing problems of contact fidelity and adhesion that are sometimes encountered when depositing metal films directly on silicon. Another advantage realized by process 300 is the use of chemical bonds to initiate the reaction, rather than a galvanic electrochemical reaction so that the initiation rate of this process will not be sensitive to the type of silicon doping material (e.g., p or n type dopants) or the concentration of the doped material as is the case with selective electroless deposition processes conventionally performed on silicon contacts.

Another advantage of process 300, in contrast to most electroless deposition processes, it that this technique may be used to deposit pure materials (such as pure Co and Ni), pure materials that are not favorable to deposit by conventional electroless deposition processes (such as pure tungsten), or alloys that are not favorable to deposit by conventional electroless deposition processes (such as very high W-content metal alloys). Because the nature of the reaction created during the processes described below depends on the Si—H surface bonds, the film growth kinetics are expected to change after a few atomic layers and be particularly well suited to applications of ultra-thin metal film deposition on silicon. Layers such as these are called for in the formation of metal silicide (e.g., nickel silicide or cobalt silicide) contacts in CMOS electronics. The low temperatures used for the deposition will be beneficial to thermal budget considerations for other thermal processing needed elsewhere in the manufacturing of the semiconductor device stack.

Another advantage is that since a chemical reaction is used to initiate growth at the semiconductor interface, this allows for a very wide range of strategies to accelerate, retard, or otherwise control the film growth characteristics. This is in contrast to conventional electroless deposition on silicon processes, which are found to be difficult to control at low film thicknesses and whose chemical composition tends to be aggressive towards the silicon interface. In one aspect, the formed ultra-thin layer could serve as the silicidation layer itself, or as a catalytic/protecting layer for subsequent electroless deposition processes (e.g., metals).

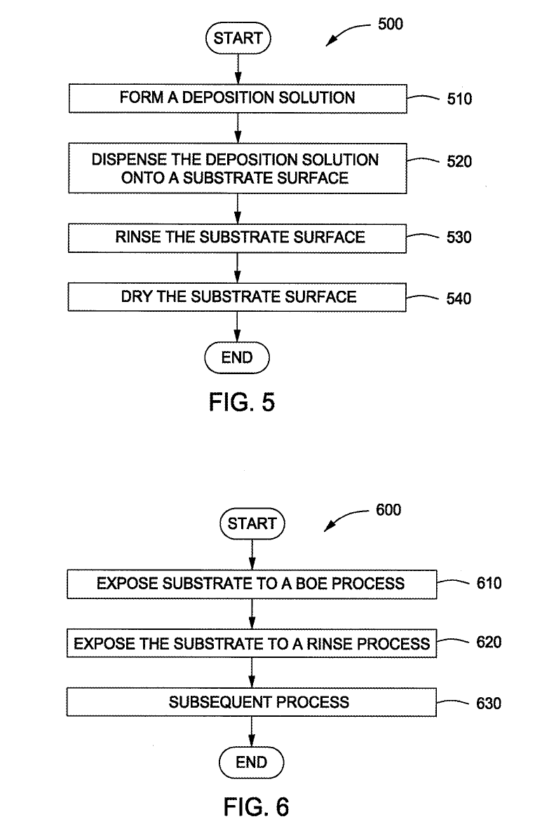

FIG. 5 illustrates a one embodiment of step 320 that has a series of method steps 510-530 that may be used to form metallic silicide hydride layer 216 on the surface of contact junction 202. In one embodiment, steps 320 and 330 are performed in the same single substrate processing chamber. In another aspect, steps 320 and 330 are performed in multiple substrate processing chambers. The first method step 510 of step 310, requires the formation of a deposition solution which will be used to deposit the metal layer on the substrate surface. Step 510 may be performed at any time prior to, or while dispensing the solution on the substrate surface. In general the deposition solution contains a solvent and a complexed metal compound. An exemplary solvent will generally have the properties that allow it to deliver the metal complex to the surface of the substrate and will not react with the silicon surface directly or enable the surface Si—H bonds to be attacked by an oxidizing agent such as water. Exemplary solvents may include acetonitrile or propylene glycol monomethyl ether (PGME). In one aspect, the solvent solution does not contain water and has a low concentration of oxygen to prevent the oxidation of the silicon surface or the complexed metal.

In one embodiment, the complexed metal compound of the deposition solution is selected so that it will react with silicon hydride layer 214, which may include carbonyl complexed metals, which are highly reactive since they have an oxidation state at or near zero. In this case a reducing agent is generally not required to perform the deposition step 520 (discussed below). Exemplary metal complexes include, but are not limited to cobalt tetracarbonyl (dicobalt octacarbonyl or Co₂(CO)₈), nickel dicyclooctadiene (bis(1,5-cyclooctadiene)nickel), and tungsten carbonyl (W(CO)₆). In general, many different types of metals may be used to form metallic silicide hydride layer 216.

In the next step, deposition step 520, an amount of the liquid deposition solution is delivered on the surface of the substrate, where it will remain for a desired period of time to allow the deposition reaction to occur. In one aspect, the process is allowed to continue until at least one or more monolayers of metal are formed on the silicon surface. Embodiments of the invention generally include ways of activating the surface, or the metal center, or both, to facilitate the deposition of a thin film (e.g., two or more monolayers). In one embodiment, the processes are carried out in oxygen and water free environments, which allow the a metal-silicon interface to be formed with very low oxygen concentration, superior to conventional chemical vapor deposition (CVD), atomic layer deposition (ALD), or electroless techniques. An example of how the reaction may proceed using cobalt tetracarbonyl and nickel dicyclooctadiene are shown below.

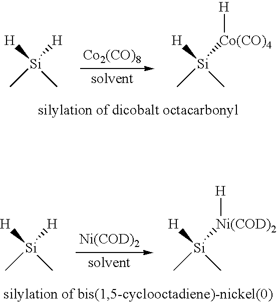

The deposition process might involve an initial series of silylation reactions at the interface, followed by dissociation of the ligands by thermal, chemical, or photolytic means (see below).

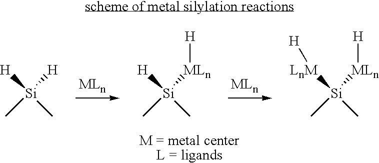

In one aspect, it is desirable for at least two monolayers of film to be formed since it is believed that this configuration will tend to shield the silicon surface of silicon junction 202 from the various components in the subsequent deposition process steps that would tend to corrode or attack the silicon surface.

In one embodiment, the deposition reaction may proceed spontaneously at room temperature, with mild thermal induction (temperatures at or below the boiling point of the solvent), with light, with the addition of a soluble reducing agent or other reagent, or any combination of the preceding.

In one embodiment, it may be desirable to add a reducing agent which can enhance the deposition of subsequent metal layers on top of the metal silicon bond formed at silicon junction 202. Classes of reducing agents may include nitrogen based reducing agents (e.g., hydrazine (H₂NNH₂)), organic-hydrogen donor based reducing agents (e.g., 1,4-hexadiene (C₆H₁₀)), and variable-valence metals based reducing agents. Variable-valence metals are utilized as metal-reductants due to the availability of electrons between redox states and include compounds of Ti³⁺/Ti⁴⁺, Fe²⁺/Fe³⁺, Cr²⁺/Cr³⁺ and Sn²⁺/Sn⁴⁺. Metal-reductants containing variable-valence metals may contain a variety of anionic ligands including complexing agents and halides, such as chlorides, fluorides, bromides, or iodides. Complexing agents that are useful may have functional groups that include carboxylic acids, dicarboxylic acids, polycarboxylic acids, amino acids, amines, diamines, polyamines, alkylamines, alkanolamines and alkoxyamines. Complexing agents may include citric acid, glycine, ethylenediamine (EDA), monoethanolamine, diethanolamine (DEA), triethanolamine (TEA), derivatives thereof, salts thereof, or combinations thereof. Variable-valence metal compounds and reducing solutions that are useful during processes described herein are further disclosed in commonly assigned U.S. Ser. No. 11/385,047, entitled “Electroless Deposition Process on a Silicide Contact,” filed Mar. 20, 2006, and in commonly assigned U.S. Ser. No. 11/385,043, entitled “Electroless Deposition Processes and Compositions within High Aspect Ratio Contacts,” filed Mar. 20, 2006, which are both incorporated herein by reference in their entirety. Also, variable-valence metal compounds and reducing solutions are further described in V. V. Sviridov et al., “Use of Ti(III) Complexes to reduce Ni, Co, and Fe in Water Solution,” J. Phys. Chem., vol. 100, pp. 19632-19635, (1996), M. Majima et al., “Development of Titanium Redox Electroless Plating Method,” SEI Technical Review, vol. 54, pp. 67-70, (June 2002), S. Nakao et al., “Electroless Pure Nickel Plating Process with Continuous Electrolytic Regeneration System,” Surface and Coatings Technology, vols. 169-170(1), pp. 132-134., (Jun. 2, 2003), which are each incorporated by reference to the extent not inconsistent with the claimed aspects and description herein.

The final two steps, steps 530 and 540, are performed to rinse and dry the substrate surface to remove any residual deposition solution on the surface of substrate 200. In step 530 the substrate surface is rinsed using a solvent, such as DI water to remove any of the remaining deposition solution. In one aspect, it may be desirable to rotate the substrate during the rinsing process to assure that the rinsing process is effective. In one aspect, it may be desirable to degas the DI water prior to dispensing it on the substrate surface to remove any dissolved gasses, such as oxygen. In step 540 a drying process is performed on the substrate to assure that the deposition solution and rinsing solvent will not affect the subsequent processing steps. In one aspect, it may be desirable to add a solvent to the rinsing solution that will promote drying of the substrate surface, such as IPA.

Optional Metal Deposition Step

In one embodiment of the invention, second metal layer 218 (FIG. 2F) is optionally deposited on metallic silicide hydride layer 216 during step 330 (FIG. 3) to assure full coverage of silicon junction 202. In one aspect, where a subsequent high temperature silicidation process is to be performed on substrate 200, it may be desirable to deposit enough metal to assure that there is an adequate amount of a metal-silicide may be formed at silicon junction 202 interface to assure reliable contacts will be formed. The process of adding second metal layer 218 may be performed using various conventional electroless, CVD or ALD deposition processes. In one aspect, second metal layer 218 is made of the same material as was deposited during step 320 and is deposited using an electroless deposition process that selectively deposits the metal layer on metallic silicide hydride layer 216. Examples of exemplary chemistries and processes that may be used to deposit second metal layer 218 or perform other aspect of the invention are further described in commonly assigned U.S. Ser. No. 11/385,290, entitled “Electroless Deposition Processes and Compositions for Forming Interconnects,” filed Mar. 20, 2006 (9916), in commonly assigned U.S. Ser. No. 11/385,047, entitled “Electroless Deposition Process on a Silicide Contact,” filed Mar. 20, 2006 (9916.02), in commonly assigned U.S. Ser. No. 11/385,344, entitled “Contact Metallization Scheme Using a Barrier Layer over a Silicide Layer,” filed Mar. 20, 2006 (9916.03), in commonly assigned U.S. Ser. No. 11/385,043, entitled “Electroless Deposition Process on a Silicon Contact,” filed Mar. 20, 2006 (9916.04), and in commonly assigned U.S. Ser. No. 11/385,484, entitled “In-situ Silicidation Metallization Process,” filed Mar. 20, 2006 (9916.05), which are all incorporated herein by reference in their entirety.

Metal Fill Step

In one embodiment of the invention, a final fill device step 340 is performed to fill contact level aperture 210 formed on substrate 200. In one aspect, step 340 is performed after step 320 is completed and thus does not require the optional step 330 (described above). In yet another aspect, step 340 is performed after steps 320 and 330 have been completed on contact level aperture 210. The last step of process 300 is the deposition a metal layer to fill contact level aperture 210 formed on substrate 200. In general, an electroless deposition process, CVD or ALD deposition process could be performed to cause metal fill layer 220 (FIG. 2G) to fill contact level aperture 210 during step 340. In one aspect, metal fill layer 220 is a tungsten containing layer that is formed using a conventional CVD tungsten deposition process. The tungsten CVD deposition process used in step 340 may be performed using conventional tungsten hexafluoride precursor chemistries at a temperature in the range between about 300° C. and about 400° C. In this step, metal fill layer 220 containing tungsten is directly deposited on metallic silicide hydride layer 216, or second metal layer 218.

In another aspect, metal fill layer 220 is a tungsten containing layer that is formed using a conventional electroless deposition process described above. Typical metals that may be deposited electrolessly to form metal fill layer 220 include, but are not limited to nickel, tungsten, tungsten alloys, cobalt alloys, or combinations thereof.

Embodiments of the invention are provided which include compositions of buffered oxide etch (BOE) solutions and methods that use the BOE solutions during a process to selectively remove a native oxide layer from a substrate surface containing thermal oxides. The BOE solutions generally contain alkanolamine compounds and an etchant, such as hydrogen fluoride. In one embodiment, the viscosity and the wetting properties of the BOE solution may be adjusted by varying a concentration ratio of at least two alkanolamine compounds.

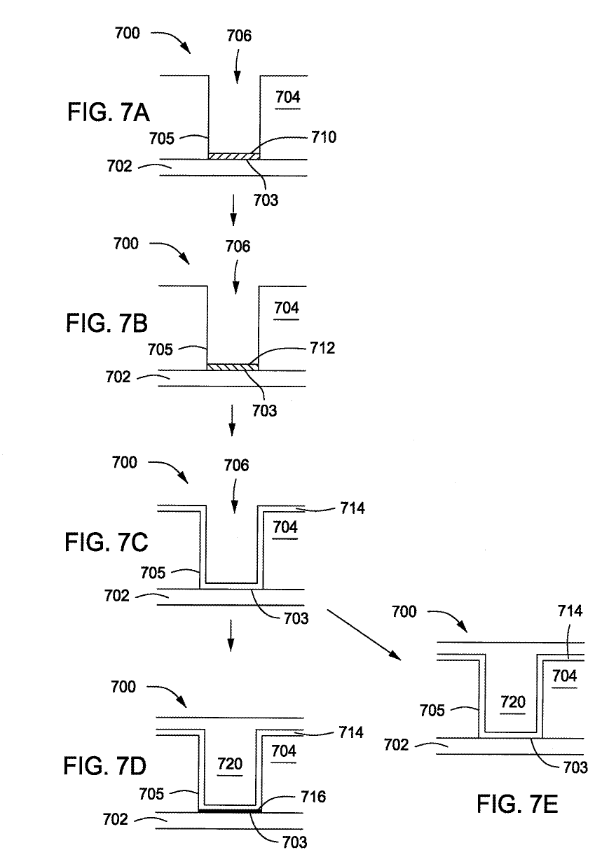

FIG. 6 illustrates a flow chart of process 600 for cleaning substrates, such as during a contact cleaning application. In one embodiment, process 600 corresponds to FIGS. 7A-7E which illustrate schematic cross-sectional views of an electronic device at different stages of an interconnect fabrication sequence. Process 600 includes step 610 for exposing substrate 700 to a BOE solution during the contact cleaning application, step 620 for rinsing substrate 700 during a rinse application and step 630 for subsequent processes, including depositing or forming at least one material on substrate 700.

In other embodiments, a substrate or substrate surface may be exposed to a BOE solution during a pretreatment process or a preclean process (e.g., contact cleaning application) during step 310 (FIG. 3), step 410, (FIG. 4) or step 610 (FIG. 6). During step 630, the subsequent process performed on substrate or substrate surface may include depositing a metal-silicide bond layer, optionally depositing a metal layer on the metal-silicide bond layer, and/or filling a device, as described in steps 320-340 (FIG. 3).

FIG. 7A illustrates a cross-sectional view of substrate 700 having contact level aperture 706 formed within dielectric layer 704. Aperture 706 contains sidewalls 705 extending from the field of substrate 700 to silicon junction 702. Dielectric layer 704 may generally contain an insulating material that includes silicon dioxide and other silicon oxides, silicon on insulator (SOI), silicon oxynitride, fluorine-doped silicate glass (FSG), or carbon-doped silicon oxides, such as SiOₓC_{y}, for example, BLACK DIAMOND® low-k dielectric, available from Applied Materials, Inc., located in Santa Clara, Calif. Contact level aperture 706 may be formed in dielectric layer 704 using conventional lithography and etching techniques to expose silicon junction 702. Alternatively, dielectric layer 704 may be deposited on silicon junction 702 forming contact level aperture 706 therein. Silicon junction 702 may be a MOS type source or a drain interface and is generally a doped (e.g., n+ or p+) silicon region of substrate 700.

Native oxide surface 710 is typically formed on exposed surface 703 of silicon junction 702 during an exposure to air or after the etching and ashing processes used to form contact level aperture 706. Native oxide surface 710 may be a continuous layer or a discontinuous layer across exposed surface 703 and include surface terminations of oxygen, hydrogen, hydroxide, halide, metals, or combinations thereof. Native oxide surface 710 formed at silicon junction 702 is generally a metastable lower quality oxide (e.g., SiOₓ, where x is between about 0.1 and 2) compared to the much more stable oxide materials that are typically used to form dielectric layer 704 (e.g., SiO₂), such as thermal oxides. The metastable lower quality oxide (e.g., the “native oxide” ) is much easier to remove from exposed surface 703 than dielectric layer 704, probably due to a lower activation energy than that of dielectric layer 704.

In one embodiment, substrate 700 may be exposed to a pretreatment process to further clean native oxide surface 710 prior to step 610. Contaminants resulting from exposure to ambient conditions may accumulate on native oxide surface 710 during or after the formation of contact level aperture 706. In one example, a contaminant is a hydrocarbon-containing or fluorocarbon-containing residue which reduces or prevents the wetting of native oxide surface 710 during subsequent processes, such as step 610. Therefore, a wet clean process may be used to remove residues and other contaminants from substrate 700, yielding native oxide surface 710 free or substantially free of contaminants. Substrate 700 may be treated by wet clean processes, such as an acidic cleaning process (e.g., a solution containing hydrochloric acid and hydrogen peroxide held at elevated temperature, such as SC2 clean), a basic cleaning process (e.g., a solution containing ammonium hydroxide and hydrogen peroxide held at elevated temperature, such as SC1 clean), or a series of wet cleans containing both acidic and basic cleaning processes.

Substrate 700 may be exposed to a BOE solution for removing native oxide surface 710 while forming hydride surface 712, as depicted in FIG. 7B. Hydride surface 712 is formed on exposed surface 703 of silicon junction 702 during step 610. Hydride surface 712 may contain silicon, silicon hydrides (e.g., SiHₓ, where x=1, 2 or 3), silicon hydroxides (e.g., Si(OH)ₓ, where x=1, 2 or 3), or combinations thereof (e.g., SiHₓ(OH)_{y}, where x=1 or 2 and y=1 or 2). In one embodiment, the formation of hydride surface 712 may be used to facilitate a subsequent metal deposition process during step 630. In general, the formation of silicon hydrides within hydride surface 712 is preferred over silicon hydroxides, since silicon hydrides have a less chance than silicon hydroxides of incorporating oxygen into subsequently deposited/formed materials (e.g., metal films or silicide contacts).

FIG. 7B illustrates a cross-sectional view of substrate 700 containing contact level aperture 706 after hydride surface 712 has been formed on silicon junction 702. In one embodiment, the metastable low quality oxide of native oxide surface 710 is selectively removed and hydride surface 712 is formed on exposed surface 703 by exposing substrate 700 to a BOE solution. Dielectric layer 704 may sustain little etching or no etching during the time period for removing native oxide surface 710. Generally, step 610 occurs for less than about 5 minutes, preferably, less than about 3 minutes, such as within a range from about 10 seconds to about 120 seconds, preferably, from about 15 seconds to about 60 seconds, for example, about 30 seconds.

The BOE solution is an aqueous solution that contains an etchant and at least one, preferably, two or more alkanolamine compounds. The etchant may be a fluorine source, such as hydrogen fluoride. The BOE solution may contain the etchant at a concentration by weight within a range from about 0.25% to about 10%, preferably, from about 0.5% to about 5%, and more preferably, from about 1% to about 3%. In one example, the etchant is hydrogen fluoride at a concentration of about 2%. The BOE solution also contains water at a concentration by weight within a range from about 80% to about 98%, preferably, from about 85% to about 95%, and more preferably, from about 88% to about 94%. In one example, BOE solution contains about 92% water.

Alkanolamine compounds are contained within the BOE solutions. In general, the alkanolamine compounds complex or interact with the fluoride ions from the dissolved hydrogen fluoride or other etchant. Therefore, the partially complexed fluoride ions become comparatively less active towards higher density silicon oxides silicate, or silicon containing materials on the surfaces of substrate 700, such as within dielectric layer 704 and similar features. The alkanolamine compounds provide other desirable properties while acting as a wetting agent, a pH buffer, a fluoride buffer, a chelating agent, or a stabilizer for the etched silicon atoms leaving the surface of substrate 700 and entering the BOE solution.

In one embodiment, two or more alkanolamine compounds may be combined at various ratios in order to control the viscosity of the BOE solution. In one example, the viscosity of the BOE solution is determined by a weight ratio of at least two alkanolamine compounds combined within the BOE solution. In another example, the viscosity is determined by a weight ratio of at least three alkanolamine compounds combined within the BOE solution. Substrate 700 may be exposed to a centrifugal spinning process while containing an aliquot of the BOE solution thereon, such as during step 610. The viscosity of the BOE solution may be adjusted in order to maintain a predetermined volume of the BOE solution on substrate 700 while being spun. Also, the wettability of substrate 700 and may be controlled by adjusting the viscosity of the BOE solution. Therefore, the selectivity of the etching may in part be controlled by the viscosity of the BOE solution. The BOE solution may have a dynamic viscosity of about 50 cP or less, preferably, about 40 cP or less, such as within a range from about 10 cP to about 30 cP, preferably, from about 12 cP to about 28 cP, and more preferably, from about 15 cP to about 25 cP. In one example, the viscosity is about 23 cP.

The weight ratio of a first alkanolamine compound to the second alkanolamine compound may be within a range from about 1 to about 10, in another example, within a range from about 1 to about 5, and in another example, within a range from about 1 to about 3, such as about 1.5 or about 1.1. The alkanolamine compounds that may be used to form the BOE solutions as described herein include monoalkanolamine compounds (RNH₂), dialkanolamine compounds (R₂NH), trialkanolamine compounds (R₃N), or combinations thereof, where each R is independently an alkanol group including methanol (HOCH₂—), ethanol (HOC₂H₄—), propanol (HOC₃H₆—), butanol (HOC₄H₈—), or derivatives thereof. In one embodiment the preferred alkanolamine compounds include ethanolamine (EA, (HOCH₂CH₂)NH₂), diethanolamine (DEA, (HOCH₂CH₂)₂NH), triethanolamine (TEA, (HOCH₂CH₂)₃N), methanolamine ((HOCH₂)NH₂), dimethanolamine ((HOCH₂)₂NH), trimethanolamine ((HOCH₂)₃N), diethanolmethanolamine ((HOCH₂)N(CH₂CH₂OH)₂), ethanoldimethanolamine ((HOCH₂)₂N(CH₂CH₂OH)), derivatives thereof, or combinations thereof.

The BOE solution may contain a first alkanolamine compound at a concentration by weight within a range from about 0.5% to about 10%, preferably, from about 1% to about 5%, and more preferably, from about 2% to about 3%. Also, the BOE solution may contain a second alkanolamine compound at a concentration by weight within a range from about 0.5% to about 10%, preferably, from about 1% to about 5%, and more preferably, from about 2% to about 3%. While in some embodiments, a composition of the BOE solution contains two different alkanolamine compounds, other embodiments provide compositions containing a single alkanolamine compound, three alkanolamine compounds, or more. Therefore, the BOE solution may contain one alkanolamine compound, preferably two different alkanolamine compounds, and may contain three or more different alkanolamine compounds depending on desired viscosity of the BOE solution. In an alternative embodiment, the BOE solution may contain a third alkanolamine compound at a concentration by weight within a range from about 0.5% to about 10%, preferably, from about 1% to about 5%, and more preferably, from about 2% to about 3%. For example, the BOE solution may contain EA, DEA, and TEA. In one embodiment, the viscosity of the BOE solution may be increased by providing a higher weight ratio TEA:DEA. Alternatively, in another embodiment, the viscosity of the BOE solution may be decreased by providing a higher weight ratio EA:DEA.

In one example, the first alkanolamine compound may be DEA and the second alkanolamine compound may be TEA. In another example, the first alkanolamine compound is DEA the second alkanolamine compound is EA. In another example, the first alkanolamine compound is TEA the second alkanolamine compound is EA. In other examples, the first alkanolamine compound is DEA at a concentration within the BOE solution to have the viscosity of the BOE solution within a range from about 15 cP to about 25 cP or at a concentration by weight of the BOE solution within a range from about 1% to about 15%. In another example, the first alkanolamine compound is DEA at a concentration of about 3% and the second alkanolamine compound is TEA at a concentration of about 2%.

The BOE solution is formed as an acidic, aqueous solution. A pH adjusting agent may be added to adjust the pH value of the BOE solution. The BOE solution may contain a pH adjusting agent at a concentration to maintain a pH value of less than about 7, preferably, less than about 6, such as within a pH range from about 3.5 to about 5, preferably, from about 3.8 to about 4.8, and more preferably, from about 4 to about 4.5. The pH adjusting agent may include additional alkanolamine compounds (e.g., EA, DEA, or TEA), additional hydrogen fluoride (HF) or hydrofluoric acid, sulfuric acid, ammonium hydroxide, tetramethylammonium hydroxide, salts thereof, derivatives thereof, or combinations thereof. In one embodiment, the pH value of the BOE solution is adjusted to the point of zero charge (PZC) of silicon, such as within a pH range from about 4 to about 4.5. Generally, silicon oxide has a PZC at a pH value of about 3.5 or less. Therefore, in one embodiment, the BOE solution has a pH value of greater than about 3.5 and less than about 6.

The etching process to selectively remove native oxides over thermal oxides may use a pre-mixed BOE solution or an in-line mixing process that combines a BOE concentrate with water to generate the BOE solution. In one example, the BOE concentrate and water are mixed at the point-of-use to efficiently and effectively form the BOE solution. The BOE solution may be formed by diluting a BOE concentrate with various ratios of water. In one example, a BOE solution is formed by combining one volumetric equivalent of a BOE concentrate and two volumetric equivalents of deionized water. In another example, a BOE solution is formed by combining one volumetric equivalent of a BOE concentrate and three volumetric equivalents of deionized water. In another example, a BOE solution is formed by combining one volumetric equivalent of a BOE concentrate and four volumetric equivalents of deionized water. In another example, a BOE solution is formed by combining one volumetric equivalent of a BOE concentrate and six volumetric equivalents of deionized water.

In one example, a BOE solution contains by weight a DEA concentration from about 2% to about 4%, preferably about 3%, a TEA concentration from about 1% to about 3%, preferably about 2%, a HF concentration from about 1% to about 3% preferably about 2%, and a water concentration from about 90% to about 96%, preferably, from about 91% to about 95%, and more preferably, about 93%. The BOE solution may have a pH value within a range from about 4 to about 4.5, such as about 4.25, and a viscosity within a range from about 15 cP to about 30 cP, such as about 23 cP.

In another example, a BOE solution contains by weight a DEA concentration from about 1% to about 3%, preferably about 2%, a TEA concentration from about 2% to about 4%, preferably about 3%, a HF concentration from about 1% to about 3% preferably about 2%, and a water concentration from about 90% to about 96%, preferably, from about 91% to about 95%, and more preferably, about 93%. The BOE solution may have a pH value within a range from about 4 to about 4.5, such as about 4.25, and a viscosity within a range from about 15 cP to about 30 cP, such as about 25 cP.

In another example, a BOE solution contains by weight a DEA concentration from about 1% to about 10%, preferably about 5%, a HF concentration from about 1% to about 3%, preferably about 2%, and a water concentration from about 90% to about 96%, preferably, from about 92% to about 94%, and more preferably, about 93%. The BOE solution may have a pH value within a range from about 4 to about 4.5, such as about 4.25, and a viscosity within a range from about 15 cP to about 30 cP, such as about 18 cP.

In another example, a BOE solution contains by weight a TEA concentration from about 1% to about 10%, preferably about 5%, a HF concentration from about 1% to about 3%, preferably about 2%, and a water concentration from about 90% to about 96%, preferably, from about 92% to about 94%, and more preferably, about 93%. The BOE solution may have a pH value within a range from about 4 to about 4.5, such as about 4.25, and a viscosity within a range from about 15 cP to about 30 cP, such as about 30 cP.

In one embodiment of step 610, a BOE solution is applied to substrate 700 having native oxide surface 710 and specifically patterned areas containing thermal oxide, such as dielectric layer 704. The BOE solution contains 0.5 M DEA-TEA-HF (0.5 M of total alkanolamines), a pH value of about 4.25, and a viscosity of about 23 cP. Substrate 700 may be maintained at room temperature (about 20° C.) and exposed to the BOE solution for about 30 seconds. Thereafter, native oxide surface 710 may be completely removed, hydride layer 712 is formed and dielectric layer 704 received little or no etching. Substrate 700 may be thoroughly rinsed with water and dried by a gas flow (e.g., N₂, H₂, Ar, or a mixture thereof) during step 620.

FIGS. 7C-7D illustrate a cross-sectional view of substrate 700 during a silicidation formation process and subsequent contact fill process, as described in one embodiment that may be implemented during step 630. FIG. 7C depicts metal layer 714 disposed over hydride surface 712 of silicon junction 702 and dielectric layer 704. In general, metal layer 714 contains a metal that forms a metal silicide with the silicon material contained in silicon junction 702 at exposed surface 703 during a subsequent thermal processing step. Metal layer 714 may contain nickel, titanium, tantalum, cobalt, molybdenum, tungsten, alloys thereof, nitrides thereof, or combinations thereof. Metal layer 714 may be selectively or non-selectively deposited using an ALD process, a PVD process, a CVD process, or an electroless deposition process. A preferred electroless process is further described in commonly assigned U.S. Ser. No. 11/385,344, entitled “Contact Metallization Scheme Using a Barrier Layer over a Silicide Layer,” filed Mar. 20, 2006 (9916.03), in commonly assigned U.S. Ser. No. 11/385,043, entitled “Electroless Deposition Process on a Silicon Contact,” filed Mar. 20, 2006 (9916.04), which are both herein incorporated by reference in their entirety. In one example, metal layer 714 contains a nickel-containing material deposited using an electroless deposition process. Metal layer 714 may be deposited having a thickness within a range from about 5 Å to about 100 Å, preferably, from about 10 Å to about 50 Å, and more preferably, from about 10 Å to about 30 Å.

Substrate 700 may be exposed to a thermal process, such as a conventional anneal process or a rapid thermal process (RTP) to form metal silicide layer 716 at the interface of metal layer 714 and silicon junction 702. Generally, the silicide formation process may be performed in a vacuum or inert environment to prevent the oxidation or damage to the surface of metal silicide layer 716 or other contact surfaces. Substrate 700 may be heated to a temperature within a range from about 300° C. to about 450° C. for a time period within a range from about 30 seconds to about 10 minutes. In one example, metal silicide layer 716 contains a nickel silicide material on exposed surface 703 at silicon junction 702. The silicide formation process step may be used to reduce the contact resistance between the metal layer 714 and silicon junction 702 within contact level aperture 706.

Optionally, a thin layer cobalt-containing layer may be deposited over metal silicide layer 716 to inhibit the diffusion of metal layer 714 into the subsequently deposited layers or other contact level aperture elements. In one example, a cobalt-containing layer is deposited before forming metal silicide layer 716 and thus is deposited directly on metal layer 714. In general the cobalt containing layer (not shown) is a binary alloy or ternary alloy, such as cobalt boride (CoB), cobalt phosphide (CoP), cobalt tungsten phosphide (CoWP), cobalt tungsten boride (CoWB), cobalt molybdenum phosphide (CoMoP), cobalt molybdenum boride (CoMoB), cobalt rhenium boride (CoReB), cobalt rhenium phosphide (CoReP), derivatives thereof, alloys thereof, or combinations thereof. In one aspect, the cobalt containing layer (not shown) may be deposited having a thickness within a range from about 5 Å to about 100 Å, preferably, from about 10 Å to about 50 Å, and more preferably, from about 10 Å to about 30 Å. Preferably, the cobalt containing layer is deposited using an electroless deposition process, such as processes described in commonly assigned U.S. Ser. No. 11/040,962, filed Jan. 22, 2005, and published as US 2005-0181226, and in commonly assigned U.S. Ser. No. 10/967,644, filed Oct. 18, 2004, and published as US 2005-0095830, which are both herein incorporated by reference in their entirety.

FIGS. 7C and 7E illustrate a cross-sectional view of substrate 700 during a barrier layer deposition process and subsequent contact fill process, as described in another embodiment that may be implemented during step 630. FIG. 7C depicts metal layer 714 disposed over hydride surface 712 of silicon junction 702 and dielectric layer 704. In general, metal layer 714 contains a metal, a metal nitride, or a metal silicon nitride. Metal layer 714 may contain tantalum, tantalum nitride, tantalum silicon nitride, titanium, titanium nitride, titanium silicon nitride, ruthenium, tungsten, tungsten nitride, alloys thereof, derivatives thereof, or combinations thereof. Metal layer 714 may be deposited or formed on sidewalls 705 of contact level aperture 706 and across hydride surface 712 and the field of substrate 700 by an ALD process, a CVD process, a PVD process, an electroless deposition process, or a combination thereof.

Metal layer 714 may contain a single layer of one material or multiple layers of varying materials. The composition of metal layer 714 may contain tantalum tantalum nitride, tantalum silicon nitride, titanium, titanium nitride, titanium silicon nitride ruthenium, tungsten, tungsten nitride, alloys thereof, derivatives thereof, or combinations thereof. In one example, metal layer 714 is formed by depositing a tantalum layer by a PVD process onto a tantalum nitride layer deposited by an ALD process. In another example, metal layer 714 is formed by depositing a tantalum layer by a PVD process onto a tantalum nitride layer deposited by a PVD process. In another example, metal layer 714 is formed by depositing a tantalum layer by an ALD process onto a tantalum nitride layer deposited by an ALD process.

Optionally, a seed layer (not shown) may be deposited on metal layer 714 prior to filling contact level aperture 706 with a conductive material to form contact plug 720. A seed layer may contain copper, ruthenium, cobalt, tantalum, titanium, tungsten, rhenium, palladium, platinum, nickel, alloys thereof, or combinations thereof and may be deposited by a PVD process, an ALD process, or an electroless deposition process.

Contact level aperture 706 may be filled with a conductive metal to form contact plug 720 thereon, as depicted in FIGS. 7D and 7E. The conductive metal contained within contact plug 720 may include copper, tungsten, aluminum, silver, alloys thereof, or combinations thereof. Contact plug 720 may be formed by depositing the conductive material during an ALD process, a PVD process, a CVD process, electrochemical plating process (ECP), an electroless deposition process, or combinations thereof. Contact plug 720 may be filled by a single conductive material during a single deposition process or contact plug 720 may be filled by multiple conductive materials during multiple deposition processes, such as by forming a seed layer, a bulk layer, and/or a subsequent fill layer. In one example, contact plug 720 is filled with copper or a copper alloy during an electroless deposition process. In another example, contact plug 720 is filled with tungsten or a tungsten alloy during an ALD process followed by a CVD process.

The processes described herein may be performed in an apparatus suitable for performing a buffered oxide etch (BOE) process or an electroless deposition process (EDP). A suitable apparatus includes the SLIMCELL™ processing platform that is available from Applied Materials, Inc., located in Santa Clara, Calif. The SLIMCELL™ platform, for example, is an integrated system capable of etching a native oxide within a wet-clean cell during a BOE process and depositing a conductive material within an EDP cell. The SLIMCELL™ platform generally includes a wet-clean cell or etch cell and one or more EDP cells as well as one or more pre-deposition or post-deposition cell, such as spin-rinse-dry (SRD) cells or annealing chambers. Process systems, platforms, chambers, and cells useful for conducting BOE processes, as well as electroless deposition processes, as described herein, are further disclosed in commonly assigned U.S. Ser. No. 10/059,572, entitled “Electroless Deposition Apparatus,” filed Jan. 28, 2002, and published as US 2003-0141018, U.S. Ser. No. 10/965,220, entitled, “Apparatus for Electroless Deposition,” filed on Oct. 14, 2004, and published as US 2005-0081785, U.S. Ser. No. 10/996,342, entitled, “Apparatus for Electroless Deposition of Metals on Semiconductor Wafers,” filed on Nov. 22 2004, and published as US 2005-0160990, U.S. Ser. No. 11/043,442, entitled, ” Apparatus for Electroless Deposition of Metals on Semiconductor Wafers,” filed on Jan. 26, 2005, and published as US 2005-0263066, U.S. Ser. No. 11/175,251, entitled, “Apparatus for Electroless Deposition of Metals on Semiconductor Wafers filed on Jul. 6, 2005, and published as US 2005-0260345, U.S. Ser. No. 11/192,993, entitled, “Integrated Electroless Deposition System,” filed on Jul. 29, 2005, and published as US 2006-0033678, which are each incorporated by reference to the extent not inconsistent with the claimed aspects and description herein.

A “substrate surface, as used herein, refers to any substrate or material surface formed on a substrate upon which film processing is performed. For example, a substrate surface on which processing may be performed include materials such as monocrystalline, polycrystalline, or amorphous silicon, strained silicon, silicon on insulator (SOI), doped silicon, fluorine-doped silicate glass (FSG), silicon germanium germanium, gallium arsenide, glass, sapphire, silicon oxide, silicon nitride, silicon oxynitride, or carbon doped silicon oxides, such as SiOₓC_{y}, for example, BLACK DIAMOND® low-k dielectric, available from Applied Materials, Inc., located in Santa Clara, Calif. Substrates may have various dimensions, such as 200 mm or 300 mm diameter wafers, as well as, rectangular or square panes. Substrates on which embodiments of the invention may be useful include, but are not limited to semiconductor wafers, such as crystalline silicon (e.g., Si<100> or Si<111>), silicon oxide, strained silicon, silicon germanium, doped or undoped polysilicon, doped or undoped silicon wafers, and patterned or non-patterned wafers. Substrates made of glass or plastic, which, for example, are commonly used to fabricate flat panel displays and other similar devices, may also be used during embodiments described herein.

### EXPERIMENTAL

### Example 1

### DEA-HF Concentrate

Diethanolamine (DEA) 99.5% (1 mole, 105.1 g) is heated to its melting point and dissolved in minimal ultra pure water to form a concentrated solution within a 500 mL vessel. To the vessel, 200 mL of diluted 10% wt. hydrofluoric acid, or 1 mole of HF is added slowly enough to prevent excessive heating of the solution. The pH value of the solution is adjusted to a desired pH range with the direct addition of 48% wt. HF or 33% wt. tetramethylammonium hydroxide (TMAH), or a non-fluoride containing acid such as sulfuric acid (H₂SO₄). The solution is diluted with pure water to a volume of 500 mL. The DEA-HF concentrate has a DEA concentration of about 2 M.

### Example 1.1

### DEA-HF Concentrate of pH 6-7

A 500 mL of DEA-HF concentrate (about 500 g) having a pH value within a range from about 6 to about 7 contains about 105 g of DEA (about 20% wt.), about 20 g of HF (about 5% wt.), and about 375 g (about 75% wt.) of water.

### Example 1.2

### DEA-HF Concentrate of pH 4-4.5

A 500 mL of DEA-HF concentrate (about 500 g) having a pH value within a range from about 4 to about 4.5 contains about 105 g of DEA (about 20% wt.), about 35 g of HF (about 7% wt.), and about 365 g (about 73% wt.) of water. The pH value is adjusted to the point of zero charge (PZC) of silicon, which is also within a range from about 4 to about 4.5.

### Example 1.3

### DEA-HF Solution

The 2 M DEA concentrate prepared in Example 1.2 is diluted by mixing with water at a ratio of 1:4. The 2 L of DEA-HF solution contains about 105 g of DEA (about 5% wt.), about 35 g of HF (about 2% wt.), and about 1,860 g (about 93% wt.) of water. The DEA-HF solution has a DEA concentration of about 0.5 M.

### Example 2

### DEA-TEA-HF Concentrate

DEA (1 mole, about 55 g) and triethanolamine (TEA) (1 mole, about 50 g) are heated to its melting point and dissolved in minimal ultra pure water to form a concentrated solution within a 500 mL vessel. To the vessel, 200 mL of diluted 10% wt. HF, or 1 mole of HF is added slowly enough to prevent excessive heating of the solution. The pH value of the solution is adjusted to a desired pH range with the direct addition of 48% wt. HF or 33% wt. TMAH, or a non-fluoride containing acid such as sulfuric acid. The solution is diluted with pure water to a volume of 500 mL. The solution has a pH value of about 4-4.5. The DEA-TEA-HF concentrate has a DEA-TEA concentration of about 2 M and a DEA:TEA weight ratio of about 1.1.

### Example 2.1

### DEA-TEA-HF Concentrate of pH 4-4.5

A 500 mL of DEA-TEA-HF concentrate (about 500 g) having a pH value within a range from about 4 to about 4.5 contains about 55 g of DEA (about 10% wt.), about 50 g of TEA (about 10% wt.), about 35 g of HF (about 7% wt.), and about 365 g (about 73% wt.) of water. The pH value is adjusted to the point of zero charge (PZC) of silicon, which is also within a range from about 4 to about 4.5.

### Example 2.2

### DEA-TEA-HF Solution

The 2 M DEA-TEA concentrate prepared in Example 2.1 is diluted by mixing with water at a ratio of 1:4. The 2 L of DEA-TEA-HF solution contains about 55 g of DEA (about 3% wt.), about 50 g of DEA (about 2% wt.), about 35 g of HF (about 2% wt.), and about 1,860 g (about 93% wt.) of water. The DEA-TEA-HF solution has a DEA-TEA concentration of about 0.5 M and a viscosity of about 23.

### Example 3

### Process Using DEA-TEA-HF Solution

A substrate is exposed to a 25 mL sample of the DEA-TEA-HF solution as described in Example 2.2. The silicon substrate, at room temperature (20° C.), has the regions of the native silicon oxide exposed in specifically patterned areas. A treatment time of 30 seconds or less was sufficient to completely remove the native oxide while causing little or no etching of the dielectric layers.

While the foregoing is directed to embodiments of the invention, other and further embodiments of the invention may be devised without departing from the basic scope thereof, and the scope thereof is determined by the claims that follow.

1. A method for depositing a material on a substrate, comprising:
exposing a substrate to a buffered oxide etch solution to form a silicon hydride layer on the substrate during a pretreatment process, wherein the buffered oxide etch solution comprises diethanolamine, triethanolamine, and hydrogen fluoride.
depositing a metal silicide layer on the substrate; and
depositing a metal material on the metal silicide layer.

2. The method of claim 1, wherein the metal silicide layer comprises cobalt, nickel, tungsten, alloys thereof, or combinations thereof.

3. The method of claim 2, wherein the metal silicide layer is deposited by exposing the substrate to a deposition solution during an electroless deposition process.

4. The method of claim 3, wherein the deposition solution comprises a solvent and a complexed metal compound.

5. The method of claim 4, wherein the complexed metal compound is selected from a group consisting of cobalt tetracarbonyl, nickel dicyclooctadiene, and tungsten carbonyl.

6. The method of claim 5, wherein the solvent is acetonitrile or propylene glycol monomethyl ether.

7. The method of claim 1, wherein the metal material comprises tungsten or a tungsten alloy.

8. The method of claim 1, wherein the buffered oxide etch solution further comprises:
the diethanolamine at a concentration by weight within a range from about 0.5% to about 10%;
the triethanolamine at a concentration by weight within a range from about 0.5% to about 10%;
the hydrogen fluoride at a concentration by weight within a range from about 0. 5% to about 10%; and
the water at a concentration by weight within a range from about 80% to about 98%.

9. The method of claim 8, wherein the buffered oxide etch solution further comprises a pH value within a range from about 3.5 to about 5 and a viscosity within a range from about 10 cP to about 30 cP.

10. The method of claim 8, wherein the buffered oxide etch solution further comprises:
the diethanolamine is at a concentration within a range from about 2% to about 3%;
the triethanolamine is at a concentration within a range from about 2% to about 3%;
the hydrogen fluoride is at a concentration within a range from about 1% to about 3%;
the water is at a concentration within a range from about 88% to about 94%;
the pH value is within a range from about 4 to about 4.5; and
the viscosity is within a range from about 15 cP to about 25 cP.

11. A method for depositing a material on a substrate, comprising:
exposing a substrate to a buffered oxide etch solution to form a silicon hydride layer on the substrate during a pretreatment process, wherein the buffered oxide etch solution comprises hydrogen fluoride and at least two of compounds selected from the group consisting of ethanolamine, diethanolamine, and triethanolamine.
depositing a metal silicide layer on the substrate; and
depositing a first metal layer on the metal silicide layer.

12. The method of claim 11, wherein the metal silicide layer comprises cobalt, nickel, tungsten, alloys thereof, or combinations thereof.

13. The method of claim 11, wherein the metal silicide layer is deposited by exposing the substrate to a deposition solution during an electroless deposition process.

14. The method of claim 13, wherein the deposition solution comprises a solvent and a complexed metal compound.

15. The method of claim 14, wherein the complexed metal compound is selected from a group consisting of cobalt tetracarbonyl, nickel dicyclooctadiene, and tungsten carbonyl.

16. The method of claim 15, wherein the solvent is acetonitrile or propylene glycol monomethyl ether.

17. The method of claim 11, further comprising depositing a second metal layer on the first metal layer.

18. The method of claim 17, wherein the second metal layer comprises tungsten or a tungsten alloy.

19. The method of claim 11, wherein the buffered oxide etch solution further comprises:
diethanolamine at a concentration by weight within a range from about 0.5% to about 10%;
triethanolamine at a concentration by weight within a range from about 0.5% to about 10%;
the hydrogen fluoride at a concentration by weight within a range from about 0.5% to about 10%; and
the water at a concentration by weight within a range from about 80% to about 98%.

20. The method of claim 19, wherein the buffered oxide etch solution further comprises a pH value within a range from about 3.5 to about 5 and a viscosity within a range from about 10 cP to about 30 cP.

21. The method of claim 19, wherein the buffered oxide etch solution further comprises:
the diethanolamine is at a concentration within a range from about 2% to about 3%;
the triethanolamine is at a concentration within a range from about 2% to about 3%;
the hydrogen fluoride is at a concentration within a range from about 1% to about 3%;
the water is at a concentration within a range from about 88% to about 94%;
the pH value is within a range from about 4 to about 4.5; and
the viscosity is within a range from about 15 cP to about 25 cP.

22. A method for depositing a material on a substrate, comprising:
exposing a substrate to a buffered oxide etch solution to form a silicon hydride layer on the substrate during a pretreatment process, wherein the buffered oxide etch solution comprises hydrogen fluoride and at least two different alkanolamine compounds.
depositing a metal silicide layer on the substrate, wherein the metal silicide layer comprises at least one element selected from the group consisting of cobalt, nickel, and tungsten; and
depositing a metal material on the metal silicide layer.

23. The method of claim 22, wherein the metal silicide layer is deposited by exposing the substrate to a deposition solution during an electroless deposition process.

24. The method of claim 23, wherein the deposition solution comprises a solvent and a complexed metal compound.

25. The method of claim 24, wherein the complexed metal compound is selected from a group consisting of cobalt tetracarbonyl, nickel dicyclooctadiene, and tungsten carbonyl.

26. The method of claim 25, wherein the solvent is acetonitrile or propylene glycol monomethyl ether.

27. The method of claim 22, wherein the metal material comprises tungsten or a tungsten alloy.

28. The method of claim 22, wherein the at least two different alkanolamine compounds are selected from the group consisting of ethanolamine, diethanolamine and triethanolamine.

29. The method of claim 28, wherein the buffered oxide etch solution further comprises:
diethanolamine at a concentration by weight within a range from about 0.5% to about 10%;
triethanolamine at a concentration by weight within a range from about 0.5% to about 10%;
the hydrogen fluoride at a concentration by weight within a range from about 0.5% to about 10%; and
the water at a concentration by weight within a range from about 80% to about 98%.

30. The method of claim 29, wherein the buffered oxide etch solution further comprises a pH value within a range from about 3.5 to about 5 and a viscosity within a range from about 10 cP to about 30 cP.

31. The method of claim 29, wherein the buffered oxide etch solution further comprises:
the diethanolamine is at a concentration within a range from about 2% to about 3%;
the triethanolamine is at a concentration within a range from about 2% to about 3%;
the hydrogen fluoride is at a concentration within a range from about 1% to about 3%;
the water is at a concentration within a range from about 88% to about 94%;
the pH value is within a range from about 4 to about 4.5; and
the viscosity is within a range from about 15 cP to about 25 cP.
